(19) United States
(12) Patent Application Publication
(10) Pub. No.: US 2011/0104520 A1
(43) Pub. Date: May 5, 2011

(54) SECONDARY BATTERY AND BATTERY PACK USING THE SAME

(76) Inventor: Changbum Ahn, Yongin-si (KR)

(21) Appl. No.: 12/910,266

(22) Filed: Oct. 22, 2010

Related U.S. Application Data
(60) Provisional application No. 61/257,417, filed on Nov. 2, 2009.

(51) Int. Cl. H01M 16/00; H01M 2/02; H01M 2/30

(52) U.S. Cl. 429/7; 429/179

(57) ABSTRACT

A secondary battery and a battery pack using the same are provided. In the secondary battery, an electrode terminal extending from an electrode assembly is structurally and electrically connected to a lead tab to turn on a circuit, and if swelling arises, the lead tab coupled to a pouch case is spaced apart from the electrode terminal due to expansion of the pouch case to break the structural connection between the electrode terminal and the lead tab, thereby turning off the circuit.

### CROSS-REFERENCE TO RELATED APPLICATIONS

This application claims priority to and the benefit of U.S. Provisional Application No. 61/257,417 filed Nov. 2, 2009, the entire content of which is incorporated by reference herein.

### BACKGROUND

1. Field

Embodiments relate to a secondary battery and a battery pack using the same.

2. Description of Related Art

Unlike primary batteries that are not designed to be rechargeable, secondary batteries are rechargeable and are widely used in various electronic devices such as cellular phones, laptop computers, and camcorders.

Among various kinds of secondary batteries, lithium secondary batteries are widely used because of their high operational voltages and high energy density per unit weight. Lithium secondary batteries are manufactured into various shapes such as prismatic shapes, cylindrical shapes, and pouch shapes.

An internal gas pressure of a secondary battery can be excessively increased due to overcharging, over-discharging, an internal short circuit, or overheating. When the internal gas pressure is too high, the secondary battery may not be normally charged/discharged but behave abnormally. In addition, a case of the secondary battery may swell due to its internal gas pressure.

### SUMMARY

Embodiments are directed to a secondary battery capable of generating an open circuit to stop charging/discharging by using a swelling phenomenon in a way different from that used in the related art, and a battery pack using the secondary battery.

Other embodiments are directed to a secondary battery capable of generating an open circuit to stop charging/discharging when swelling arises by structurally breaking the electrical connection between an electrode assembly and a lead tab, and a battery pack using the secondary battery.

According to the embodiments, the secondary battery and the battery pack using the same are configured so that the electrode terminal and the lead tab can be separated by the deformation of the pouch case that swells due to an increase in the internal gas pressure.

Therefore, when swelling of the case occurs, the electrical connection between the electrode assembly and the lead tab can be structurally broken. This way, the secondary battery and the battery pack can be used more reliably.

In an embodiment according to the present invention, a secondary battery includes: an electrode assembly including a first electrode, a second electrode, and a separator between the first and second electrodes; a case containing the electrode assembly; a terminal electrically coupled to the first electrode; and a lead tab electrically coupled to the first electrode via the terminal inside the case, extending to outside of the case, and configured to be separated from at least a portion of the terminal to be electrically decoupled from the first electrode if the case is deformed while the lead tab remains attached to the case.

The secondary battery may further include an adhesive attaching the lead tab to the terminal, the adhesive having an opening therethrough, wherein the lead tab is electrically coupled to the terminal through the opening.

The secondary battery may further include a coupling member attaching a portion of the lead tab to the case, wherein the coupling member is closer to an attachment position between the lead tab and the terminal than an attachment position of another portion of the lead tab to the case.

The terminal and the lead tab may be electrically coupled to each other via spot welding. The terminal and the lead tab may be electrically coupled to each other at least one contact.

The secondary battery may further include an adhesive attaching the lead tab to the terminal, wherein the lead tab is electrically coupled to the terminal via at least one contact on a first side of the adhesive and at least one other contact on a second side of the adhesive opposite the first side.

The case may include a deformable portion, wherein the lead tab is attached to the deformable portion, such that the lead tab is configured to be electrically decoupled from the first electrode as the deformable portion is deformed. The deformable portion may have a sloped surface between two parallel walls of the case.

The terminal may have a groove thereon that at least partially surrounds a contact region on which a conductive contact between the terminal and the lead tab is located.

The case may include a deformable portion, the lead tab is attached to the deformable portion, and the contact region is configured to be separated from the rest of the terminal when the deformable portion is deformed. The groove may completely surround the contact region. The groove may partially surround the contact region at an edge of the terminal.

The terminal may include a material for providing a resistance of about 10 mΩ or lower.

The secondary battery may further include a coupling member for attaching the lead tab to an inner surface of the case. The secondary battery may further include a supporting member for attaching the terminal to an inner surface of the case. An attachment strength between the terminal and the lead tab may be lower than an attachment strength of the coupling member to the case and the lead tab.

The terminal may include a first plate and a second plate stacked together, a strength of the first plate is lower than that of the second plate and the electrical conductivity of the first plate is higher than that of the second plate, and the first plate is electrically coupled to the lead tab via a conductive contact.

In another embodiment according to the present invention, a battery pack includes: a plurality of secondary batteries; and a circuit board for controlling the secondary batteries. At least one of the secondary batteries includes: an electrode assembly including a first electrode, a second electrode, and a separator between the first and second electrodes; a case containing the electrode assembly; a terminal electrically coupled to the first electrode; and a lead tab electrically coupled to the first electrode via the terminal inside the case, extending to outside of the case, and configured to be separated from at least a portion of the terminal to be electrically decoupled from the first electrode if the case is deformed while the lead tab remains attached to the case, wherein the lead tab is electrically coupled to a lead tab of at least another one of the secondary batteries.

### BRIEF DESCRIPTION OF THE DRAWINGS

FIG. 1 is a perspective view illustrating a battery pack in an assembled state, according to an embodiment.

FIG. 2 is a perspective view illustrating one of a plurality of secondary batteries of the battery pack of FIG. 1.

FIG. 3 is a sectional view taken along the line III-III of FIG. 2.

FIG. 4 is an exploded perspective view illustrating a connection part of FIG. 3.

FIG. 5 is a sectional view that illustrates changes to the secondary battery of FIG. 3 when the secondary battery swells.

FIG. 6 is a simplified process diagram that illustrates the process by which the swelling and open circuit depicted in FIG. 5 is generated.

FIG. 7 is a perspective view that illustrates a welding method between a positive terminal and a first lead tab according to another embodiment.

FIG. 8 is a sectional view illustrating a coupling structure between a positive terminal and a first lead tab according to another embodiment.

FIG. 9 is a perspective view illustrating the positive terminal of FIG. 8.

FIG. 10 is a perspective view illustrating a positive terminal according to another embodiment.

FIG. 11 is a sectional view illustrating a coupling structure between a positive terminal and a first lead tab according to another embodiment.

### DETAILED DESCRIPTION

A secondary battery and a battery pack using the same will now be described with reference to the accompanying drawings according to example embodiments.

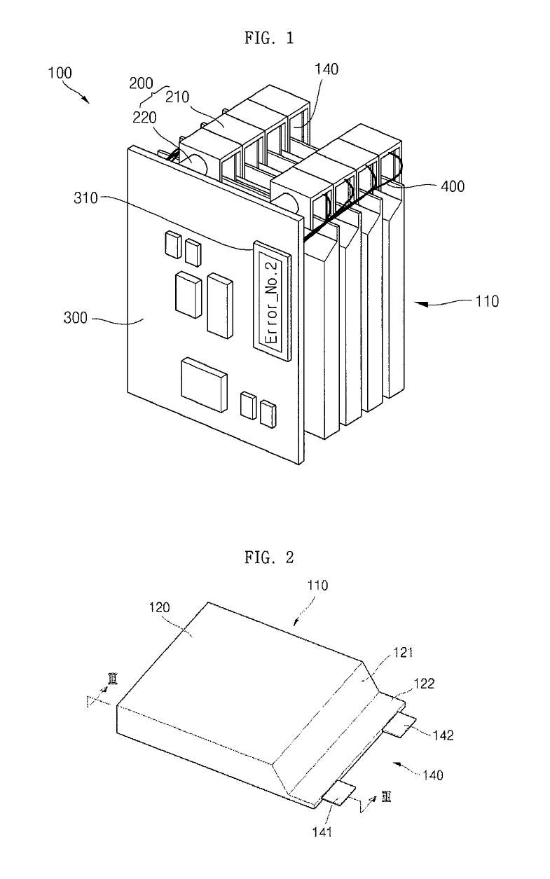

FIG. 1 is a perspective view illustrating a battery pack 100 in an assembled state, according to an embodiment.

Referring to FIG. 1, the battery pack 100 includes a plurality of secondary batteries 110, a connection part 200, a circuit board 300, and a detecting device 400.

The secondary batteries 110 are stacked in a manner such that main surfaces of the secondary batteries 110 face each other. In other words, the side surfaces of the secondary batteries 110 are parallel to each other. The charge/discharge capacity of the battery pack 100 increases in proportion to the number of the secondary batteries 110. The battery pack 100 may be used for a large apparatus such as a hybrid electric vehicle (HEV) or an electric vehicle (EV) requiring a high battery capacity, rather than a small apparatus such as a cellular phone to which power can be sufficiently supplied by using only one secondary battery 110. However, the present invention is not limited thereto. The secondary batteries 110 include exposed lead tabs 140.

The connection part 200 electrically connects together the lead tabs 140 having the same polarity. In other words, the lead tabs 140 having positive polarity are electrically connected to each other by the connection part 200, and the lead tabs 140 having negative polarity are electrically connected to each other by the connection part 200. The connection part 200 includes connection plates 210 located between the neighboring secondary batteries 110, and a connection bar 220 electrically connected to the outermost one of the connection plates 210. The connection part 200 may be formed of a conductive metal such as copper, nickel, or aluminum that has good electrical conductivity.

The circuit board 300 is used to control the charging and discharging operations of the secondary batteries 110, and only one circuit board 300 may be provided for the plurality of secondary batteries 110. The circuit board 300 may be electrically connected to the secondary batteries 110 through the connection bars 220. Since the secondary batteries 110 are controlled by the single circuit board 300, the battery pack 100 can have a simple structure as compared with the case where the circuits are provided for the respective secondary batteries 110.

The circuit board 300 is electrically connected to the detecting device 400, which is inserted in the respective lead tabs 140 or coupled to the outsides of the lead tabs 140. For example, the detecting device 400 may be a wire through which voltage variations of the secondary batteries 110 can be detected by the circuit board 300. The circuit board 300 includes an additional display 310 in the embodiment of FIG. 1. The display 310 may output information measured through the detecting device 400. Information output on the display 310 may be primarily referred to when the battery pack 100 is tested.

FIG. 2 is a perspective view illustrating one of the secondary batteries 110 of the battery pack 100 illustrated in FIG. 1.

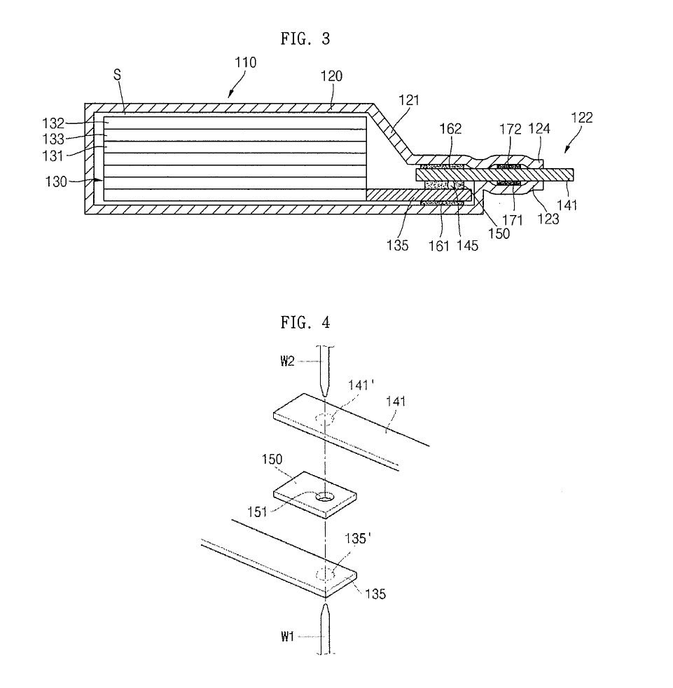

Referring to FIG. 2, the secondary battery 110 includes a pouch case 120, an electrode assembly 130 (shown FIG. 3), and lead tabs 140.

The pouch case 120 may have an approximately rectangular parallelepiped shape. The pouch case 120 is formed of a thin plate made of a metal such as aluminum. By coating opposing surfaces of the thin plate with a resin, the pouch case 120 may be electrically insulated from objects making contact with the coated surfaces.

One side of the pouch case 120 may be sloped to form a sloped surface 121. An end region or sealing part 122 extends from the sloped surface 121 to cover or clamp the lead tabs 140.

The electrode assembly 130 is contained together with electrolyte in an inner space (S) (refer to FIG. 3) formed by the pouch case 120. An end of each of the lead tabs 140 is connected (e.g., electrically connected) to the electrode assembly 130, and the other end of the lead tab 140 is exposed to the outside of the pouch case 120.

The lead tabs 140 include a first lead tab 141 and a second lead tab 142 that are spaced apart from each other in the width direction of the sealing part 122. The first lead tab 141 may be electrically connected to a positive or negative electrode plate and may be positive or negative electrically. The second lead tab 142 may be electrically connected to a negative or positive electrode plate and may have a polarity electrically opposite to that of the first lead tab 141.

FIG. 3 is a sectional view taken along the line III-III of FIG. 2.

Referring to FIG. 3, the electrode assembly 130 includes a positive electrode plate 131, a negative electrode plate 132, and a separator 133 located between the positive electrode plate 131 and the negative electrode plate 132.

The positive electrode plate 131 is formed by coating a positive electrode collector with a positive electrode coating, and the negative electrode plate 132 is formed by coating a negative electrode collector with a negative electrode coating.

The positive electrode collector of the positive electrode plate 131 is formed of a conductive metal so that electrons can be collected from the positive electrode coating to the positive electrode collector and then transferred to an external circuit when the secondary battery 110 is charged. The positive electrode coating in one embodiment is prepared by mixing a positive electrode active material, a conductive material and a binder, and is coated on the positive electrode collector (e.g., coated to a predetermined thickness).

The negative electrode collector of the negative electrode plate 132 is formed of a conductive metal so that electrons can be collected from the negative electrode coating to the negative electrode collector and then transferred to an external circuit when the secondary battery 110 is discharged. The negative electrode coating is prepared by mixing a negative electrode active material, a conductive material and a binder, and is coated on the negative electrode collector (e.g., coated to a predetermined thickness).

The separator 133 is formed of an insulating material so that the positive electrode plate 131 and the negative electrode plate 132 can be electrically insulated from each other.

The positive electrode plate 131, the separator 133, and the negative electrode plate 132 are located in the inner space (S) (e.g., accommodation space) of the electrode assembly 130 in a state where the positive electrode plate 131, the separator 133, and the negative electrode plate 132 are sequentially stacked, or they are sequentially stacked and wound in a jelly role shape. Then, electrolyte is injected into the inner space (S) to impregnate the electrode assembly 130 with the electrolyte.

A conductive positive terminal 135 extends form the positive electrode plate 131 of the electrode assembly 130. The positive terminal 135 is formed of a material for providing a resistance of about 10 mΩ or lower so that a current level required by a middle-capacity or large-capacity battery can flow through the positive terminal 135. The positive terminal 135 is connected to the conductive first lead tab 141. The positive terminal 135 and the first lead tab 141 are electrically connected through a conductive connection part 145.

As two parts of the pouch case 120 forming the sealing part 122, that is, a case lower part 123 and a case upper part 124, are sealed, the first lead tab 141 is covered by the parts 123 and 124. By sealing the two parts 123 and 124, the inner space (S) can be sealed in a state where the electrode assembly 130 and the electrolyte are contained in the inner space (S).

The first lead tab 141 is located higher than the positive terminal 135 such that the case lower part 123 of the sealing part 122 can be elevated in a stepped shape to a level higher than the lowermost outer surface of the pouch case 120.

A supporting member 161 is located between the positive terminal 135 and the pouch case 120 to support and fix the positive terminal 135 with respect to the pouch case 120. For example, the supporting member 161 may be formed of an insulating tape.

A coupling member 162 is located between the first lead tab 141 and the pouch case 120 so as to couple the first lead tab 141 to the inner surface of the pouch case 120. The coupling member 162 may be formed of a material having a high coupling strength such as polypropylene film or polyethylene film.

Although both the supporting member 161 and the coupling member 162 are described, only the coupling member 162 may be used or required if the positive terminal 135 is firmly coupled to the electrode assembly 130. If the positive terminal 135 is firmly coupled to the electrode assembly 130, when the secondary battery 110 swells, although the coupling member 162 causes the first lead tab 141 to be deformed together with the pouch case 120 in a manner such that the first lead tab 141 is spaced apart from the positive terminal 135, the supporting member 161 functions relatively less so that the supporting member 161 may be omitted.

An adhesive member 150 such as an insulating tape may be additionally located between the positive terminal 135 and the first lead tab 141. Both sides of the adhesive member 150 are respectively bonded to the surfaces of the positive terminal 135 and the lead tab 140 that face each other. The surfaces (main surfaces) of the positive terminal 135 and the first lead tab 141 that face each other may be spaced (e.g., at a predetermined distance) from each other by the adhesive member 150.

Because of the adhesive member 150, structurally firm coupling (bonding) can be made between the positive terminal 135 and the first lead tab 141. Therefore, even if the secondary battery 110 receives impacts or external forces during a normal operation, the possibility of disconnection of the conductive connection part 145 can be reduced because of the adhesive member 150. Therefore, during a normal operation of the electrode assembly 130, stable electrical connection can be ensured between the electrode assembly 130 and an external circuit.

Insulating tapes 171 and 172 may be located between the opposite sides of the first lead tab 141 and the sealing part 122 of the pouch case 120. The insulating tapes 171 and 172 provide insulation between the first lead tab 141 and the sealing part 122.

Although only the connection structure between the positive terminal 135 and the first lead tab 141 is discussed, a negative terminal, which is connected to the negative electrode plate 132 and extends in a manner corresponding to the second lead tab 142, may be connected to the second lead tab 142 in substantially the same structure.

FIG. 4 is an exploded perspective view illustrating the connection part 45 of FIG. 3.

Referring to FIG. 4, a penetration hole 151 is formed through the adhesive member 150 which is located between the positive terminal 135 and the first lead tab 141. Except for a region of the adhesive member 150 where the penetration hole 151 is formed, the adhesive member 150 is bonded to the mutually facing surfaces of the positive terminal 135 and the first lead tab 141.

For spot welding, electrodes W1 and W2 may be located at regions of the positive terminal 135 and the first lead tab 141 corresponding to the penetration hole 151, that is, regions 135′ and 141′. In detail, the first electrode W1 of which an end makes contact with the region 135′ is aligned in a row with the second electrode W2 of which an end makes contact with the region 141′, and the first and second electrodes W1 and W2 are pushed against the regions 135′ and 141′. For a short time, a current is allowed to flow through the first and second electrodes W1 and W2 across the positive terminal 135 and the first lead tab 141, which generates Joule heat. Owing to this Joule heat, the mutually facing surfaces of the regions 135′ and 141′ of the positive terminal 135 and the first lead tab 141 may be fused together and adhere to each other. Then, as the adhered portions cool and harden to form the conductive connection part 145.

A plurality of conductive connection parts 145 can be formed (at different positions) by repeating spot welding. The coupling (welding) strength between the positive terminal 135 and the first lead tab 141 can be increased by increasing the number of spot welding processes (e.g., spot welding locations).

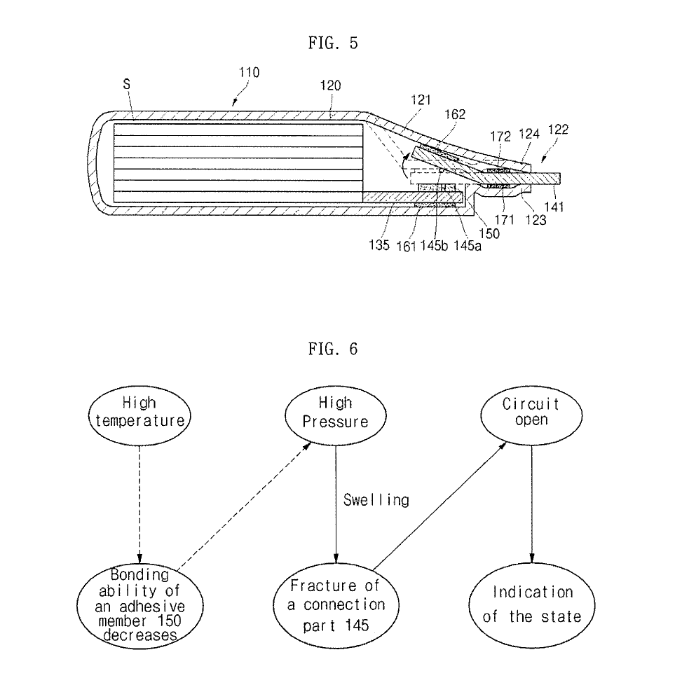

FIG. 5 is a sectional view for that illustrates changes to the secondary battery 110 illustrated in FIG. 3 when the secondary battery 110 swells, and FIG. 6 is a simplified process diagram that illustrates the process by which the swelling and open circuit depicted in FIG. 5 is generated.

Referring to FIGS. 5 and 6, if the inside temperature (e.g., inner temperature) of the secondary battery 110 increases and the inside gas pressure of the secondary battery 110 increases to a certain level due to extreme conditions such as overcharging and over-discharging, the pouch case 120 can swell, which is called a “swelling phenomenon.” Both ends of the pouch case 120 in the length direction may be inflated primarily, and particularly, the sloped surface 121 may expand the most.

If the sloped surface 121 expands outward, an end part of the first lead tab 141, which is connected to the sloped surface 121 by the coupling member 162 and is located in the inner space (S), is also bent outward. Due to this deformation, the end of the first lead tab 141 is pulled away from the positive terminal 135. Thus, if the internal gas pressure exceeds a certain level, the first lead tab 141 may be separated from the positive terminal 135. Due to this separation, mainly, the connection part 145 may be split into two parts 145a and 146b.

As the two parts 145a and 145b are separated, the electrical connection between the positive terminal 135 and the first lead tab 141 is structurally destroyed. That is, the electrode assembly 130 is electrically disconnected from an external circuit.

The fracture of the connection part 145 can occur according to the above-described mechanism when the fracture occurs before the coupling member 162 is separated from the pouch case 120 or the first lead tab 141. For this, the welding strength between the positive terminal 135 and the first lead tab 141 (the strength of the connection part 145) is lower than the bonding strength of the coupling member 162 to the pouch case 120 and the first lead tab 141. For example, if the former strength is 2.5 kgf or lower, the latter strength may be 3.0 kgf or higher. If the latter strength has the above-mentioned value, the coupling member 162 is not stripped even if the coupling member 162 is pulled away from the pouch case 120 or the first lead tab 141 at a speed of 50 mm/min.

If any one of the plurality of secondary batteries 110 is disconnected from an external circuit, this will be detected through the detecting device 400 (shown in FIG. 1). Then, the circuit board 300 connected to the detecting device 400 may control the other secondary batteries 110 or report the malfunctioning of one of the secondary batteries 110. For this end, the circuit board 300 may include the display 310 shown in FIG. 1) or a light emitting unit. In the example shown in FIG. 1, the display 310 indicates that No. 2 secondary battery 110 is malfunctioning.

In the case where the adhesive member 150 is used, the function of the adhesive member 150 related to fracture of the connection part 145 will now be described. When the temperature of the secondary battery 110 increases, heat is concentrated at the positive terminal 135 and the first lead tab 141. If heat is transferred to the adhesive member 150 from a part such as the positive terminal 135, the temperature of the adhesive member 150 increases and the bonding ability of the adhesive member 150 decreases. Thus, after a period of time (e.g., predetermined time) from the start of malfunction of the secondary battery 110, the positive terminal 135 and the first lead tab 141 are not firmly coupled by the adhesive member 150. Unlike the case where the secondary battery 110 operates normally, when the secondary battery 110 operates abnormally, the adhesive member 150 cannot prevent separation of the positive terminal 135 from the first lead tab 141.

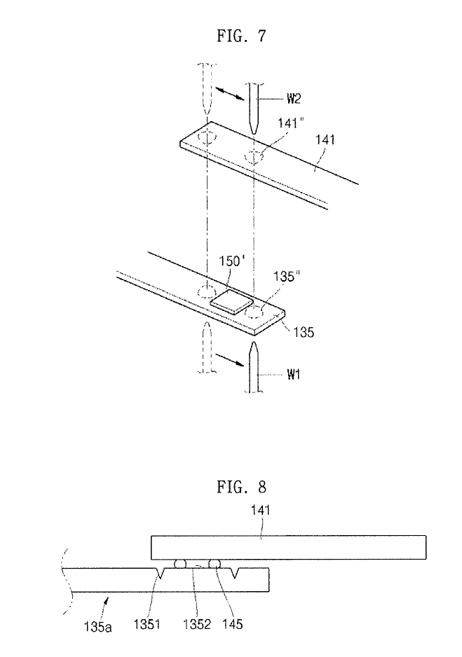

FIG. 7 is a perspective view that illustrates a welding method between the positive terminal 135 and the first lead tab 141 according to another embodiment.

Referring to FIG. 7, unlike the embodiment of FIG. 4, a penetration hole is not formed through an adhesive member 150′. Instead, the adhesive member 150′ is smaller than that illustrated in the previous embodiment and is bonded to the mutually facing surfaces of the positive terminal 135 and the first lead tab 141.

The adhesive member 150′ is located at the center between the mutually facing parts of the positive terminal 135 and the first lead tab 141, such that both sides of the mutually facing parts can be used as welding regions 135″ and 141″. In the current embodiment, the welding regions 135″ and 141″ are located close to both sides of the adhesive member 150′.

In this structure, spot welding may be performed two times by using two electrodes W1 and W2. Then, the positive terminal 135 and the first lead tab 141 may be coupled to each other through two connection parts (refer to the connection part 145 of FIG. 3).

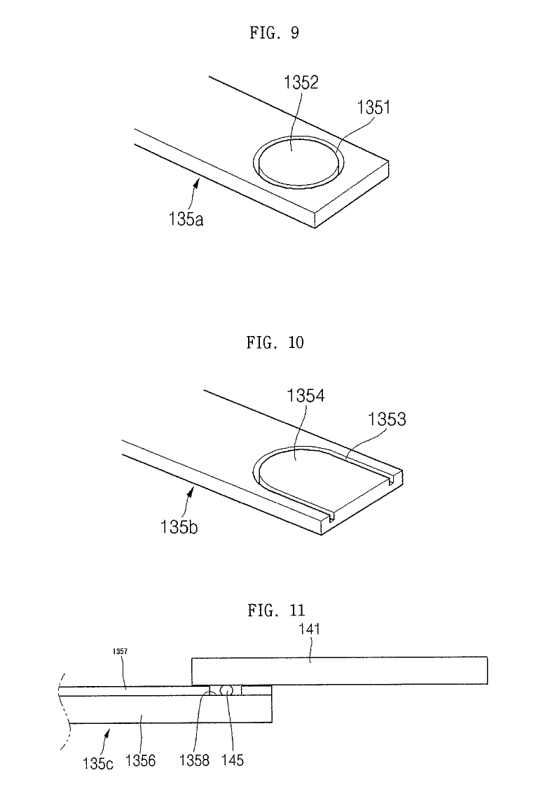

FIG. 8 is a sectional view illustrating a coupling structure between a positive terminal 135a and a first lead tab 141 according to another embodiment, and FIG. 9 is a perspective view illustrating the positive terminal 135a of FIG. 8.

Referring to FIGS. 8 and 9, similar to the previous embodiment, the positive terminal 135a and the first lead tab 141 are coupled to each other through conductive connection parts 145 formed by welding. Further, similar to the previous embodiment, an adhesive member 150 may be additionally provided between the positive terminal 135a and the first lead tab 141.

Referring again to FIGS. 8 and 9, a groove 1351 is formed in the positive terminal 135. The groove 1351 may have a closed loop shape such as a circular shape as shown in FIG. 9. The conductive connection parts 145 are located in a region 1352 defined by the groove 1351.

Even if the conductive connection parts 145 do not fracture during a swelling phenomenon, the positive terminal 135a and the first lead tab 141 can be separated from each other if the region 1352 of the positive terminal 135a defined by the groove 1351 is separated from the other region of the positive terminal 135a.

FIG. 10 is a perspective view illustrating a positive terminal 135b according to another embodiment.

Referring to FIG. 10, a groove 1353 has a non-closed-loop shape, and opened end parts of the groove 1353 extend to an end of a positive terminal 135b. A connection part may be located in a region 1354 defined by the groove 1353 and the end of the positive terminal 135b.

In this structure, the region 1354 may be separated from the other region of the positive terminal 135b more easily as compared with the case of the region 1352 of the previous embodiment.

FIG. 11 is a sectional view illustrating a coupling structure between a positive terminal 135c and a first lead tab 141 according to another embodiment.

Referring to FIG. 11, the positive terminal 135c may have a cladding structure in which a first plate 1356 and a second plate 1357 are coupled to each other. The strength of the first plate 1356 is lower than that of the second plate 1357 but the electrical conductivity of the first plate 1356 is higher than that of the second plate 1357. The first lead tab 141 is connected to the first plate 1356 having higher electrical conductivity through a connection part 145. The second plate 1357 enhances the overall rigidity of the positive terminal 135c.

The second plate 1357 has an opened region 1358 at the center of an end part. The connection part 145 is located in the region 1358.

Because of this structure, the strength of the positive terminal 135c can be increased while maintaining the electrical conductivity of the positive terminal 135c. Therefore, when the first lead tab 141 is deformed, the positive terminal 135c may not be pulled by the first lead tab 141 but the positive terminal 135c may maintain its position. Thus, the first lead tab 141 can be separated from the positive terminal 135c more easily.

Furthermore, during a swelling phenomenon, a part of the positive terminal 135c corresponding to the first lead tab 141, the connection part 145, and the region 1358 may be separated from the other part of the positive terminal 135c more easily.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims and their equivalents.

What is claimed is:

1. A secondary battery comprising:
an electrode assembly comprising a first electrode, a second electrode, and a separator between the first and second electrodes;
a case containing the electrode assembly;
a terminal electrically coupled to the first electrode; and
a lead tab electrically coupled to the first electrode via the terminal inside the case, extending to outside of the case, and configured to be separated from at least a portion of the terminal to be electrically decoupled from the first electrode if the case is deformed while the lead tab remains attached to the case.

2. The secondary battery of claim 1, further comprising an adhesive attaching the lead tab to the terminal, the adhesive having an opening therethrough, wherein the lead tab is electrically coupled to the terminal through the opening.

3. The secondary battery of claim 1, further comprising a coupling member attaching a portion of the lead tab to the case, wherein the coupling member is closer to an attachment position between the lead tab and the terminal than an attachment position of another portion of the lead tab to the case.

4. The secondary battery of claim 1, wherein the terminal and the lead tab are electrically coupled to each other via spot welding.

5. The secondary battery of claim 1, wherein the terminal and the lead tab are electrically coupled to each other at least one contact.

6. The secondary battery of claim 1, further comprising an adhesive attaching the lead tab to the terminal, wherein the lead tab is electrically coupled to the terminal via at least one contact on a first side of the adhesive and at least one other contact on a second side of the adhesive opposite the first side.

7. The secondary battery of claim 1, wherein the case comprises a deformable portion, wherein the lead tab is attached to the deformable portion, such that the lead tab is configured to be electrically decoupled from the first electrode as the deformable portion is deformed.

8. The secondary battery of claim 7, wherein the deformable portion has a sloped surface between two parallel walls of the case.

9. The secondary battery of claim 1, wherein the terminal has a groove thereon that at least partially surrounds a contact region on which a conductive contact between the terminal and the lead tab is located.

10. The secondary battery of claim 9, wherein the case comprises a deformable portion, the lead tab is attached to the deformable portion, and the contact region is configured to be separated from the rest of the terminal when the deformable portion is deformed.

11. The secondary battery of claim 9, wherein the groove completely surrounds the contact region.

12. The secondary battery of claim 9, wherein the groove partially surrounds the contact region at an edge of the terminal.

13. The secondary battery of claim 1, wherein the terminal comprises a material for providing a resistance of about 10 mΩ or lower.

14. The secondary battery of claim 1, further comprising a coupling member for attaching the lead tab to an inner surface of the case.

15. The secondary battery of claim 14, further comprising a supporting member for attaching the terminal to an inner surface of the case.

16. The secondary battery of claim 14, wherein an attachment strength between the terminal and the lead tab is lower than an attachment strength of the coupling member to the case and the lead tab.

17. The secondary battery of claim 1, wherein the terminal comprises a first plate and a second plate stacked together, a strength of the first plate is lower than that of the second plate and the electrical conductivity of the first plate is higher than that of the second plate, and the first plate is electrically coupled to the lead tab via a conductive contact.

18. A battery pack comprising:
a plurality of secondary batteries; and
a circuit board for controlling the secondary batteries,
wherein at least one of the secondary batteries comprises:
an electrode assembly comprising a first electrode, a second electrode, and a separator between the first and second electrodes;
a case containing the electrode assembly;
a terminal electrically coupled to the first electrode; and
a lead tab electrically coupled to the first electrode via the terminal inside the case, extending to outside of the case, and configured to be separated from at least a portion of the terminal to be electrically decoupled from the first electrode if the case is deformed while the lead tab remains attached to the case, wherein the lead tab is electrically coupled to a lead tab of at least another one of the secondary batteries.
